(19) United States
(12) Patent Application Publication
(10) Pub. No.: US 2006/0146769 A1
(43) Pub. Date: Jul. 6, 2006

(54) Method of operating a WLAN mobile station

(76) Inventors: Anil N. Patel, Coral Springs, FL (US); Suhas Mitra, San Diego, CA (US); Carlos A. Rivera-Cintron, Lake Worth, FL (US); Brian K. Smith, Wellington, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/027,425

(22) Filed: Dec. 31, 2004

(51) Int. Cl. H04Q 7/24

(52) U.S. Cl. 370/338; 455/574

(57) ABSTRACT

A wireless local area network (WLAN) mobile station (110, 112, 114) has an application processor core (204) and a WLAN processor (202). So as to conserve energy, when the two processors are not needed, they are both placed in a minimal power consumption mode. The WLAN processor operates a WLAN radio and receives beacon transmissions from an access point (120). Upon extracting the beacon data from a received beacon signal, the WLAN processor passes the beacon data to the application processor. To ensure receipt of the beacon data, the WLAN processor remains active until the application processor acknowledges receipt of the beacon data before transitioning back to a sleep mode. To prevent keeping the WLAN processor waiting longer than necessary, the application processor wakes up ahead of the beacon receipt time, in time to allow transition to an awake mode so that it is active by the time the WLAN processor passes the beacon data.

### TECHNICAL FIELD

This invention relates in general to wireless local area networks (WLANs), and more particularly to power saving operation of WLAN mobile stations having a first processor for processing data received from and transmitted to the WLAN, and a second processor for performing the transmitting and receiving, where each processor is capable of operating in either an awake (active) mode or a sleep (low power) mode.

### BACKGROUND OF THE INVENTION

Wireless local area networks (WLANs) combine network connectivity with portability, allowing wireless network connectivity for devices such as computers, personal digital assistants, wireless phones, and other devices generally referred to as wireless stations. A wireless station, can move about within range of a WLAN base station, referred to as an access point, which typically connects to a wired network and acts as a bridge and router between wireless stations and the wired network. A growing number of applications can be supported over a WLAN, such as simple internet access and up to streaming real time data, such as video and voice calling. In the future no doubt additional applications will be developed.

Access points serve as the master timing source for the wireless stations. Each wireless station associated with a given access point must synchronize to that access point's timer. To facilitate synchronization, access points broadcast beacon signals, or simply beacons. Beacons, in addition to other information, contain information about the state of the access point's timer so that wireless stations can adjust their own timer to run in synchronization with the access point. Being in synchronization allows the wireless stations to place portions of the WLAN circuitry into a sleep state, and become active in time to receive information from the access point at periodic intervals, if desired. Beacons also allow wireless stations to determine the quality of the signal received from the access point, and compare it with neighboring access points to determine if a change in association is necessary.

One arrangement in a WLAN wireless station comprises a dual processor design using an application processor and a WLAN processor. Each processor includes hardware and software elements for performing different processes. A WLAN processor performs the function of what is commonly referred to as a network interface card, using a WLAN radio to access the WLAN medium, which is an air interface between the WLAN wireless station and an access point, or in some cases between WLAN wireless stations. The application processor operates between the WLAN processor and the higher level network layers of the software architecture of the wireless station. After the WLAN processor has received information over the WLAN medium, such as a beacon, it passes the information to the application processor which operates on the data and passes the data to higher layers of the operating system architecture.

Due to the highly mobile environments in which the wireless station operates, in operating the wireless station, it is desirable to conserve battery power so as to extend operation time between battery recharges or changes. It is a common technique to place the application processor into low power and WLAN processor into sleep mode. While in the low power (or sleep) mode the processors are unable to process information, but they typically draw a fraction of the electrical current they draw while operating in an active (or awake) mode, where they do process information. This technique extends battery life substantially.

In a dual processor arrangement, the WLAN processor wakes up at a target beacon transmission time to receive a beacon. After receiving the beacon, the WLAN processor asserts an interrupt to the application processor. The interrupt causes the application processor to wake up and service the interrupt, which comprises processing the beacon data that has been passed to it by the WLAN processor, and also resetting the interrupt, which triggers the WLAN processor to go back to sleep. In order to save maximum power, the application processor's low power mode requires all but one of the processor's clocks to be turned off. Due to this, the processor has a relatively high latency in going back to the awake mode (as an example, in an industry leading processor this time is 2 milliseconds). During this period of time, no instructions can be executed by the application processor. Furthermore, any peripheral device requiring the attention of the application processor may become awake and waste power while waiting for the application processor to be ready to execute instructions. One such peripheral device is the WLAN processor, and due to the periodic nature of WLAN beacon processing, this idle time seriously degrades battery life.

Therefore there is a need to avoid having the WLAN processor sitting idle in active mode while the application processor wakes up to service the interrupt.

### BRIEF DESCRIPTION OF THE DRAWINGS

FIG. 1 shows a wireless local area network, in accordance with one embodiment of the present invention;

FIG. 2 shows a generalized schematic block diagram of a WLAN mobile station, in accordance with an embodiment of the invention;

FIG. 3 shows a flow chart diagram of a method of operating a WLAN mobile station for power reduction, in accordance with an embodiment of the invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

The invention solves the problem of having the WLAN processor sitting idle in active mode while waiting for the application processor to wake up by waking up the application processor ahead of the expected time at which the WLAN processor will set the interrupt line to the application processor. By waking up the application processor prior to the time the WLAN processor is finished receiving the beacon, the WLAN processor can reset the interrupt as soon as it is asserted by the WLAN processor, allowing the WLAN processor to go back to sleep rather than wait for the application processor to become awake.

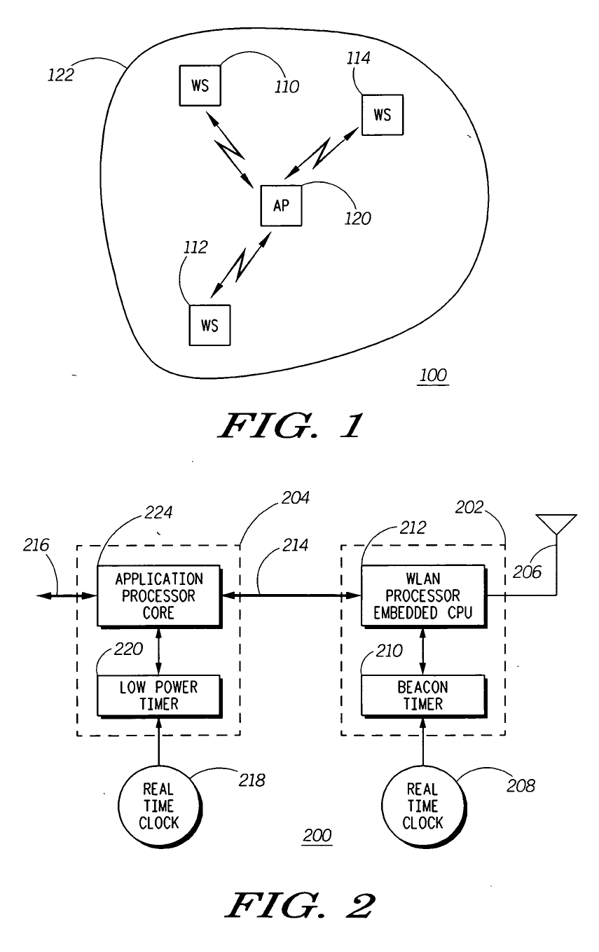

FIG. 1 shows a wireless local area network (WLAN) 100, in accordance with one embodiment of the present invention. WLAN 100 includes one or more wireless communication devices referred to herein as wireless stations 110, 112, and 114, and at least one access point 120. Access point 120 is typically connected to an infrastructure network, which in turn may be connected to other wired and wireless networks, as is known in the art. Wireless stations 110, 112, 114 include radio transmitters and receivers for transmitting and receiving signals such as voice data for voice over IP communication, data packets, control frames, and network management frames, for example. Wireless stations 110, 112, 114 can communicate wirelessly with access point 120. Access point 120 has a serving area 122 within which wireless stations can receive signals from, and transmit signal to access point 120. Wireless stations 110, 112, 114 are associated with access point 120.

The beacon signal between the access point and wireless station, commonly referred to simply as a beacon, includes, for example, an access-point timestamp, a beacon interval value, a basic service set identification (BSSID), and a traffic indication map (TIM). The access point timestamp contains timer information from the access point such as a copy of the access point's timing and synchronization function (TSF) timer, to be used for synchronizing time-sensitive operations between an access point and wireless stations associated with the access point. The beacon interval value indicates the time between two targeted start times of a beacon transmission. In one embodiment, the beacon interval is substantially 102.4 milliseconds. The BSSID is an identifier assigned to the local network serving the wireless stations and the access points. The traffic indication map, an information element present within beacon frames generated by access points, contains a delivery traffic information message (DTIM) count that indicates how many beacons will appear before the next DTIM, a DTIM period indicating the number of beacon intervals between successive DTIMs, a bitmap control field that provides an indication of broadcast or multicast frames buffered at the access point, and a traffic-indication virtual bitmap containing information corresponding to traffic buffered for a specific station within the BSS that the access point is prepared to deliver at the time the beacon frame is transmitted. The DTIM is a beacon signal that contains a DTIM after which an access point sends out buffered broadcast and multicast media access control (MAC) service data units (MSDU), followed by any unicast frames. The beacon signal may also include within the beacon frame fields containing information such as capability information, supported rates, and parameters related to frequency hopping (FH) or direct sequence spread spectrum (DSSS) physical layers (PHYs).

Referring now to FIG. 2, there is shown a schematic block diagram 200 of a WLAN mobile station, in accordance with an embodiment of the invention. The WLAN mobile station includes a WLAN processor 202, which provides access to the radio channel for an application processor 204. The WLAN processor includes a Beacon Timer 210 and an embedded CPU 212. The embedded CPU 212 is a general purpose CPU. The Beacon Timer 210 is programmed by the embedded CPU 212 to wake up the WLAN processor 202 in order to receive the next beacon. The WLAN processor and application processor communicate, for example, via a bus 214, such as a serial bus. The application processor communicates with other portions of the WLAN mobile station, for example, via bus 216. Data can be routed to various tasks and processes operating in the WLAN mobile station, such as, for example, a telephony application and data applications such as text messaging and email or other Internet access activity. The WLAN processor controls a WLAN radio and performs all of the transmission and reception, modulation and demodulation, encryption and decryption, timing, channel contention, and so on, so that data may be transmitted and received over a WLAN channel. The WLAN processor 202 is coupled to an antenna 206, which may be a diversity antenna comprised of 2 antenna elements, as is common. Timing is performed by use of a clock 208. The sleep mode results when the WLAN processor is shut down, so as to consume little or no power. Since WLAN activity is periodic and typically short in duration, the WLAN processor can be shut down when not needed, resulting in a substantial power savings, which results in prolonged operation of a battery powered WLAN mobile station. The clock allows the radio to become active at the right time so as to service traffic streams and receive periodic signals, such as beacons, from the access point. On the application processor side, a Real-Time Clock 218 is used to maintain the minimal processor functionality required during the low power mode, including the Low Power Timer 220. The Low Power Timer 220 may be operably coupled to application processor core 224. The application processor programs timer 220 via interface 222. After the application processor enters the low power mode the clock 218 continues incrementing the timer 220. When timer 220 reaches the programmed time value, it will assert an interrupt signal via interface 222 to wake up the application processor. In one embodiment of the invention, the value programmed in the timer 220, a variable named WakeUpTime, is a value corresponding to the time which will allow the application processor core 204 to be ready to receive the next beacon interrupt from the WLAN processor.

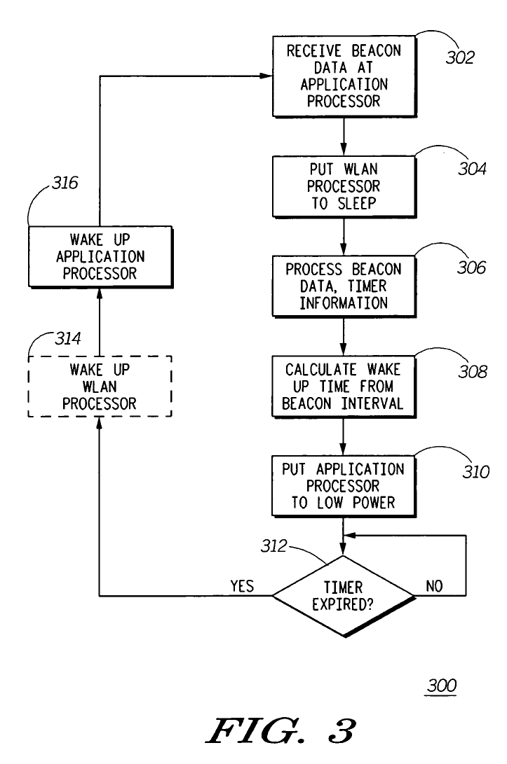

Referring now to FIG. 3, there is shown a flow chart diagram 300 of a method of operating a WLAN mobile station for power reduction, in accordance with an embodiment of the invention. The method requires that the WLAN mobile station first receive a beacon from an access point. The beacon is received at the WLAN radio and the beacon data is extracted from the radio frequency signal by the WLAN processor by demodulating and decoding the radio frequency WLAN signal from the access point. The beacon data is then passed from the WLAN processor to the application processor 302. According to the invention, the application processor is operating in awake mode by the time the beacon data is ready to be passed from the WLAN processor to the application processor, having just transitioned to the awake mode from a low power. After passing the data to the application processor, the WLAN processor transitions to a sleep mode 304, to further conserve power. In one embodiment the WLAN processor goes to sleep after receiving an indication from the application processor that the data has been received, such as by an interrupt line or a message over the serial bus, for example. Subsequent to receiving the beacon data, the application processor processes the beacon data and extracts the timing information including, for example, the beacon interval, the DTIM period and the TSF timer data 306. In one embodiment of the invention, the application processor sets up a low power timer so that it may transition to a low power mode until the next beacon needs to be processed. However, to prevent the WLAN processor from remaining active longer than necessary, the application processor sets the low power time so that it will wake up and be fully transitioned to the awake mode just before the WLAN processor generates the received Beacon interrupt. One way the low power timer may be programmed, in accordance with the invention, is by taking the beacon interval received in the beacon and subtracting a value corresponding to the time it takes for the application processor to transition from the low power to the awake mode 308. This transition time is referred to as the wake up time. The WakeUpTime in milliseconds equals:
(DTIMPeriod−1)*BeaconInterval+RemainingTime−LowPowerToAwakeLatency (1)
Where:
WakeUpTime is programmed in the LowPowerTimer 220; and
DTIMPeriod is the Delivery TIM Period which indicates which Beacons will indicate the delivery of Broadcast or Multicast frames.

For example, a value of 3 allows the wireless station to wake up for every third beacon, instead of every beacon sent by the access point. The RemainingTime indicates the amount of time remaining to the next Beacon. The BeaconInterval indicates the time between successive Beacons. The LowPowerToAwakeLatency is the time it takes for the application processor to wake up from low power mode and start executing instructions.

Once the wake up time is calculated, the result is programmed into the application processor's low power timer and the application processor may go to low power 310. Once the application has transitioned to the low power mode, the timer runs until it expires 312. During a majority of the time the application processor is in low power mode, the WLAN processor is also in sleep mode. At some time prior to the transmission of the next beacon, the WLAN processor must wake up and transition to the active mode 314. Depending on how long it takes for the WLAN processor to transition from sleep to active mode it may initiate the transition before or after the application processor begins to transition from low power to the awake mode 316. Subsequently the method is repeated.

The invention therefore provides a method of operating a WLAN mobile station to reduce power consumption of the WLAN mobile station. The WLAN mobile station includes an application processor and a WLAN processor. The method commences by waking up the WLAN processor from a sleep mode to an active mode prior to the transmission of a beacon by an access point with which the WLAN mobile station is currently associated. The WLAN processor then commences receiving the beacon, including beacon data. Prior to the time the WLAN processor is ready to pass the beacon data to the application processor, the application processor wakes up from the low power mode to the awake mode in time to receive the beacon data from the WLAN processor, whereupon the WLAN processor commences passing the beacon data to the application processor. Subsequently the method includes placing the WLAN processor in the sleep mode after passing the beacon data to the application processor. Furthermore, once the application processor processes the beacon data, the application processor is placed into low power. The application processor is operating in the awake mode when the WLAN processor is ready to pass the beacon data to the application processor.

In one embodiment of the invention, waking up the application processor involves determining a low power timer value by equation (1). Once the low power timer value is determined, the application processor commences programming the low power timer value. Upon expiration of the low power timer, the application processor commences transitioning from the low power to the awake mode.

In one embodiment of the invention, placing the WLAN processor to sleep after passing the beacon data, is performed upon receiving an indication from the application processor at the WLAN processor that the application processor has received the beacon data. This may be performed by the application processor resetting an interrupt, or by sending a message over the bus, for example.

The invention further provides a wireless station for use in a wireless local area network, having a WLAN processor for accessing the WLAN medium, including transmitting signals to, and receiving signals from an access point, including receiving beacon signals transmitted by the access point at periodic intervals. The WLAN processor has an active mode and an sleep mode, where the sleep mode requires less operating power than the active mode. The wireless station further includes an application processor that is operably coupled to the WLAN processor for processing data received from the WLAN processor, and for formatting data to be transmitted by the WLAN processor. The application processor is likewise operable in an mode and an low power mode. The WLAN processor transitions from the low power mode to the awake mode to receive a beacon signal, including beacon data, and passes the beacon data to the application processor upon receiving the beacon signal. The application processor transitions from the low power mode to the awake mode in time to receive the beacon data from the WLAN processor, and subsequently acknowledges receipt of the beacon data to the WLAN processor. The WLAN processor transitions from the active mode to the sleep mode upon the application processor acknowledging receipt of the beacon data.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method of operating a wireless local area network (WLAN) mobile station, the mobile station having an application processor and a WLAN processor, the application processor and WLAN processor each having an awake and a sleep mode of operation, the sleep mode being a lower power mode than the awake mode, the method comprising:
waking up the WLAN processor from the sleep mode to the awake mode prior to the transmission of a beacon by an access point with which the WLAN mobile station is currently associated;
receiving the beacon at the WLAN mobile station, including beacon data;
waking up the application processor from the sleep mode to the awake mode in time to receive the beacon data from the WLAN processor;
passing the beacon data to the application processor from the WLAN processor;
placing the WLAN processor in the sleep mode after passing the beacon data to the application processor; and
placing the application processor into the sleep mode after processing the beacon data;
wherein the application processor is operating in the awake mode when the WLAN processor is ready to pass the beacon data to the application processor.

2. A method of operating a WLAN mobile station as defined in claim 1, wherein waking up the application processor in time to receive the beacon data comprises:
upon receiving a previous beacon and beacon data, including a beacon interval value, calculating a low power timer value based on the DTIMPeriod, BeaconInterval, RemainingTime and LowPowerToAwakeLatency;
programming the low power timer value into a low power timer; and
transitioning from a low power mode to an awake mode upon expiration of the low power timer.

3. A method of operating a WLAN mobile station as defined in claim 2, wherein the low power timer is internal to the application processor.

4. A method of operating a WLAN mobile station as defined in claim 2, wherein the low power timer is external to the application processor

5. A method of operating a WLAN mobile station as defined in claim 1, wherein placing the WLAN processor to sleep after passing the beacon date is performed upon receiving an indication from the application processor at the WLAN processor that the application processor has received the beacon data.

6. A wireless station for use in a wireless local area network (WLAN), comprising:
a WLAN processor for accessing a WLAN medium, including transmitting signals to and receiving signals from an access point, and including receiving beacon signals transmitted by the access point at periodic intervals, the WLAN processor having an active mode and a sleep mode, the sleep mode requiring less operating power than the active mode
an application processor operably coupled to the WLAN processor for processing data and being operable in an awake mode and a sleep mode;
wherein the WLAN processor transitions from the sleep mode to the active mode to receive a beacon signal, including beacon data, and passes the beacon data to the application processor upon receiving the beacon signal;
wherein the application processor transitions from the sleep mode to the awake mode in time to receive the beacon data from the WLAN processor, and subsequently acknowledges receipt of the beacon data to the WLAN processor; and
wherein the WLAN processor transitions from the active mode to the sleep mode upon the application processor acknowledging receipt of the beacon data.

7. A wireless station as defined in claim 6, wherein the application processor programs a low power timer associated with the application processor with a value so that the application processor transitions from the sleep mode to the awake mode in time to receive the beacon data.
